(19) United States
(12) Patent Application Publication
(10) Pub. No.: US 2019/0347619 A1
(43) Pub. Date: Nov. 14, 2019

(54) PROBLEM SOLUTION SYSTEM

(71) Applicant: JTEKT CORPORATION, Osaka-shi (JP)

(72) Inventors: Kazuma SUZUKI, Kariya-shi (JP); Guangyu ZHU, Shanghai (CN); Tomotaka HANJI, Nishio-shi (JP); Teruo OKUMURA, Toyohashi-shi (JP)

(73) Assignee: JTEKT CORPORATION, Osaka-shi (JP)

(21) Appl. No.: 16/400,154

(22) Filed: May 1, 2019

(30) Foreign Application Priority Data
May 10, 2018 (JP) 2018-091635

(51) Int. Cl. G06Q 10/10; G06Q 10/06; G06Q 50/00

(52) U.S. Cl. CPC G06Q 10/103; G06Q 50/01; G06Q 10/06398

(57) ABSTRACT

A problem solution system includes a problem information storage unit configured to store problem information input by a presenter, a member storage unit configured to store a plurality of persons including at least persons other than the presenter and designated as members of a problem solution team for the problem information, and an opinion exchange tool configured such that each of the plurality of designated members is allowed to input an opinion about planning or implementation of a solution to the problem information and the plurality of members are allowed to view the opinion.

### INCORPORATION BY REFERENCE

The disclosure of Japanese Patent Application No. 2018-091635 filed on May 10, 2018 including the specification, drawings and abstract, is incorporated herein by reference in its entirety.

### BACKGROUND OF THE INVENTION

### 1. Field of the Invention

The present invention relates to a problem solution system.

### 2. Description of the Related Art

In companies, employees carry out improvement activities every day. For example, the improvement activity refers to an activity to find a problem, plan a solution, and implement the solution. The employee's improvement activity may be used for evaluation of an employee's ability. In general, the evaluation of the employee's ability based on the improvement activity is a subjective evaluation carried out by a supervisor.

Japanese Patent No. 5916460 (JP 5916460 B) describes a management system in which employees' ideas, proposals, and the like can be registered, viewed, and revised. The system is configured to manage a series of operations including registration of an employee's idea, creation (registration) of a proposal based on the idea, request for circulation of the proposal, circulation of the proposal among persons concerned, reception of the proposal at a receiving section, and visualization and changing of a circulation route and a circulation status.

Japanese Patent No. 5136026 (JP 5136026 B) describes that, when a trouble that needs to be solved is received and a plan for measures against the trouble is input, a plurality of cases where the trouble is solved by taking the input measures and effects of the measures are displayed in a list. Thus, anyone can easily determine an optimum measure by taking some measures tentatively and comparing the degrees of effects with reference to the displayed list.

As in the case of the technology described in JP 5136026 B, it is effective to plan and implement a solution with reference to some cases where a problem is solved. It is also important to effectively utilize an actual operator's ability as well as the previous cases where the problem is solved. In the improvement activity, it is particularly important to utilize the ability of the operator other than a person who presents the problem rather than a case where the person who presents the problem plans and implements the solution alone. An ability to present a problem differs from an ability to plan and implement a solution. Therefore, it is effective to separate an activity to present a problem from an activity to plan and implement a solution.

### SUMMARY OF THE INVENTION

It is one object of the present invention to provide a problem solution system in which a solution to a presented problem can be planned and implemented more effectively.

A problem solution system according to one aspect of the present invention includes:

a problem information storage unit configured to store problem information input by a presenter;

a member storage unit configured to store a plurality of persons including at least persons other than the presenter and designated as members of a problem solution team for the problem information; and

an opinion exchange tool configured such that each of the plurality of designated members is allowed to input an opinion about planning or implementation of a solution to the problem information and the plurality of members are allowed to view the opinion.

The member storage unit stores the plurality of persons as the members of the problem solution team. The plurality of members include at least the persons other than the presenter. The plurality of members are designated to belong to one problem solution team, and plan or implement the solution. That is, the plurality of members can plan or implement the solution to the problem information as a team. Thus, the plurality of members can solve the problem by utilizing their abilities.

In particular, the problem solution system includes the opinion exchange tool. The opinion exchange tool is configured such that each of the plurality of members is allowed to input the opinion about the planning or implementation of the solution to the problem information and the plurality of members are allowed to view the opinion. That is, an environment is established such that the plurality of members can mutually exchange opinions. As a result, the plurality of members can easily solve the problem as a team.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a functional block diagram of a problem solution system;

FIG. 2 is a diagram illustrating display contents of a message board tool;

FIG. 3 is a diagram illustrating display contents of a problem information input tool in a “problem found” status;

FIG. 4 is a diagram illustrating display contents of a member designation tool in an “addressing” status, and illustrates a state in which no member is designated for a problem solution team;

FIG. 5 is a diagram illustrating display contents of the member designation tool in the “addressing” status, and illustrates a state in which a leader is designated and candidates for assistants (target section) and assistants (other section) are displayed;

FIG. 6A is a diagram illustrating display contents of an opinion exchange tool in the “addressing” status;

FIG. 6B is a diagram illustrating display contents of the opinion exchange tool in the “addressing” status;

FIG. 7 is a diagram illustrating display contents of the opinion exchange tool in an “addressed” status;

FIG. 8 is a diagram illustrating display contents of the problem information input tool in a “problem solved” status;

FIG. 9 is a diagram illustrating ability elements related to an improvement ability to be evaluated by an improvement ability evaluation unit and data related to the ability elements;

FIG. 10 is a diagram illustrating display contents of the improvement ability evaluation unit; and

FIG. 11 is a diagram illustrating another form of the display contents of the improvement ability evaluation unit.

### DETAILED DESCRIPTION OF EMBODIMENTS

An overview of a problem solution system 1 is described. For example, the problem solution system 1 is targeted at operators in a production factory, and includes a tool for presenting problem information related to operations, and a tool related to planning and implementation of a solution to the presented problem information. That is, the problem solution system 1 can easily and effectively solve a problem.

The problem solution system 1 uses applications at a computer terminal operable by each operator. In particular, it is more efficient to use a mobile terminal operable by each operator. A stationary terminal may be used instead.

In the problem solution system 1, a plurality of members solve a problem (plan and implement a solution) in cooperation. The plurality of members include at least persons other than an operator who presents problem information (presenter). The plurality of members may exclusively be persons other than the presenter, or may be the presenter and a person other than the presenter.

In particular, the problem solution system 1 actively utilizes such a scheme that an operator who presents problem information (presenter) differs from an operator who plans and implements a solution to the problem information (member of a problem solution team). That is, the problem solution system 1 utilizes such a scheme that an ability to present problem information differs from an ability to plan and implement a solution. The problem solution system 1 enables an operator other than the presenter of problem information to plan and implement a solution easily and efficiently. That is, the problem solution system 1 is configured to solve a problem by separating an activity to present problem information from an activity to plan and implement a solution. However, the present invention is not limited to this configuration.

In the problem solution system 1, planning and implementation of a solution can easily and efficiently be achieved by a problem solution team of a plurality of members. That is, the problem solution team can be formed efficiently. The plurality of members belonging to the problem solution team plan and implement a solution. Since the plurality of members can plan and implement a solution to problem information as a team, the problem can be solved through effective utilization of members' abilities and cooperation among the members.

In this embodiment, the planning and implementation of a solution are collectively referred to as problem solution without a clear distinction. The problem solution team of this embodiment is a team for both the planning of a solution and the implementation of a solution. The planning of a solution and the implementation of a solution may be distinguished and problem solution teams may be formed for the individual processes. The problem solution team may be intended only for the planning of a solution, or may be intended only for the implementation of a solution.

The problem solution system 1 is not limited to operators in a production factory, but may be intended for persons in a wide variety of business fields. Description is given below of an exemplary case where the problem solution system 1 is intended for operators in a production factory.

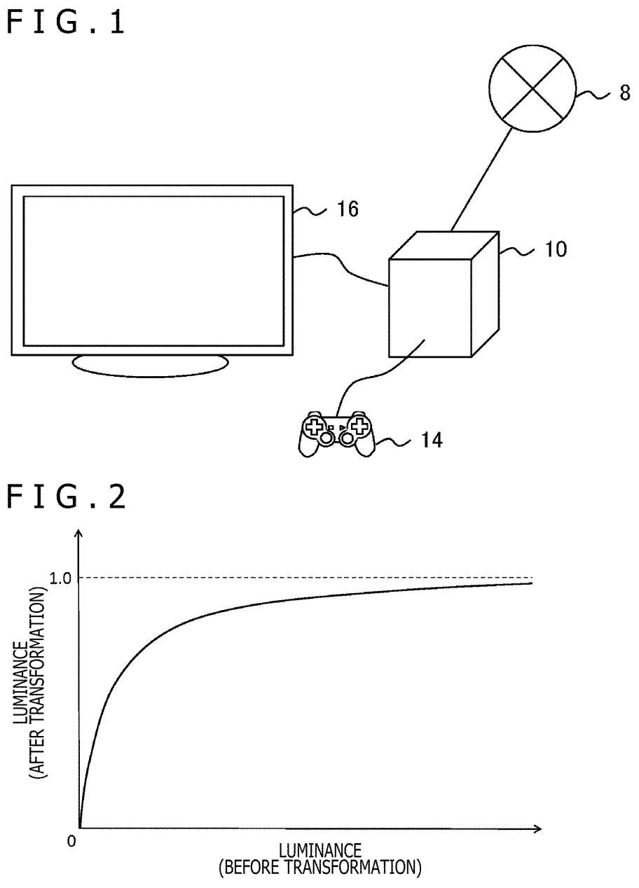

The configuration of the problem solution system 1 is described with reference to FIG. 1 to FIG. 10. As illustrated in FIG. 1, the problem solution system 1 includes a display unit 11, a message board tool 12, a message board information storage unit 13, a problem information input tool 14, a problem information storage unit 15, a member designation tool 16, an operator information storage unit 17, a member storage unit 18, an opinion exchange tool 19, an opinion information storage unit 20, and an improvement ability evaluation unit 21. In FIG. 1, parenthesized terms outside the blocks of the respective tools 12, 14, 16, and 19 denote persons who operate the tools.

The display unit 11 is a display of the mobile terminal or a display of the stationary terminal. For example, a plurality of operators each have the display unit 11, and can view display contents. The display unit 11 may be shared among the plurality of operators.

The message board tool 12, the problem information input tool 14, the member designation tool 16, and the opinion exchange tool 19 are applications installed in the mobile terminal or the stationary terminal. The message board information storage unit 13, the problem information storage unit 15, the operator information storage unit 17, the opinion information storage unit 20, and the improvement ability evaluation unit 21 are functions of a server connected to the plurality of terminals by wire or wireless. The plurality of terminals and the server construct a network.

Apart from the configuration described above, the mobile terminal or the stationary terminal may have a function of the display unit 11 and input functions of the respective tools, and the server may have application functions of the respective tools and functions of the respective storage units and the improvement ability evaluation unit 21. For example, the server may be a cloud server.

The message board tool 12 is a tool for displaying message board information 12a on the display unit 11. The message board information 12a is stored in the message board information storage unit 13. For example, the message board tool 12 is installed in the mobile terminal or the stationary terminal, and is executable in the mobile terminal or the stationary terminal.

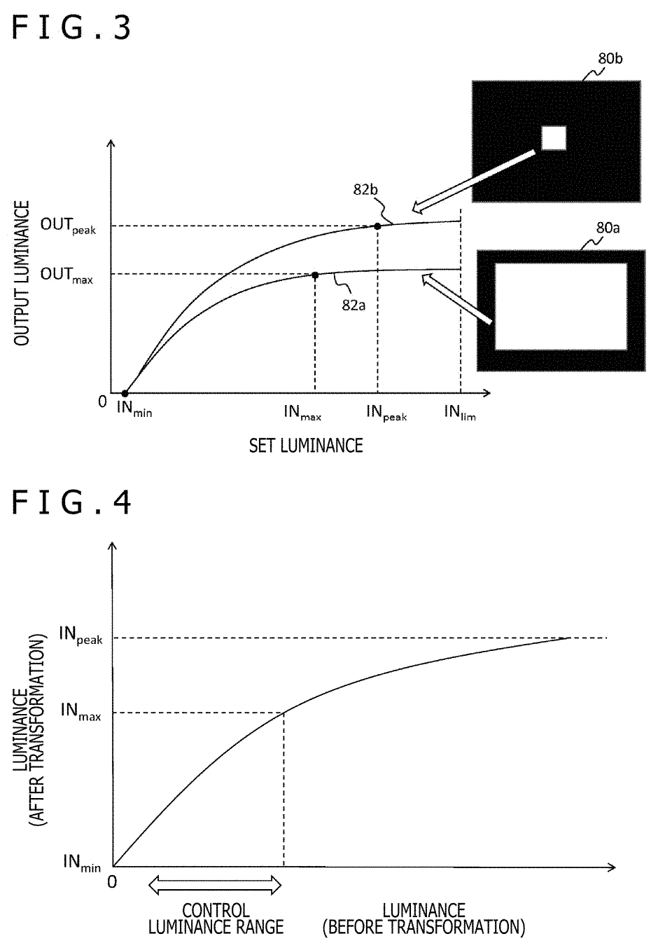

As illustrated in FIG. 2, the message board information 12a displayed on the display unit 11 differs among the operators. FIG. 2 illustrates message board information 12a of an operator Y. The operator Y belongs to a department P1 of a division P. Therefore, information related to the department P1 of the division P is displayed on the display unit 11 as the message board information 12a of the operator Y.

The message board information 12a includes an operator name, a department/division name, a “problem found” sheet, an “addressing” sheet, an “addressed” sheet, and a “problem solved” sheet. The terms “problem found”, “addressing”, “addressed”, and “problem solved” correspond to statuses in chronological order. The “problem found”, “addressing”, “addressed”, and “problem solved” sheets are displayed in relation to the department or division to which the operator belongs.

The “problem found” sheet is a sheet indicating that problem information related to an operation is presented by a presenter but no measures are currently taken. The “addressing” sheet is a sheet indicating a state in which a solution to the problem information is being planned or implemented by a problem solution team. The “addressed” sheet is a sheet indicating a state in which the solution has been implemented by the problem solution team and a presenter's check is being required. The “problem solved” sheet is a sheet indicating a state in which the presenter has checked the details of the implementation of the solution.

In FIG. 2, the message board information 12a is information related to the department P1 of the division P to which the operator Y belongs. All the operators can view not only the message boards of their departments or divisions but also message boards of other sections. Each sheet may be set so that the range of departments or divisions where the sheet can be viewed is limited, or may be set so that the sheet is open to all the departments or divisions. That is, the disclosure range of each sheet can be set.

The message board information storage unit 13 stores the message board information 12a associated with information stored in the problem information storage unit 15, the member storage unit 18, and the opinion information storage unit 20.

The problem information input tool 14 is used for inputting problem information 14a. The problem information input tool 14 is a tool that allows the operator to input the problem information 14a as a presenter. For example, the problem information input tool 14 is installed in the mobile terminal or the stationary terminal, and is executable in the mobile terminal or the stationary terminal. For example, the problem information input tool 14 is a touch panel of the mobile terminal or an input device connected to the stationary terminal.

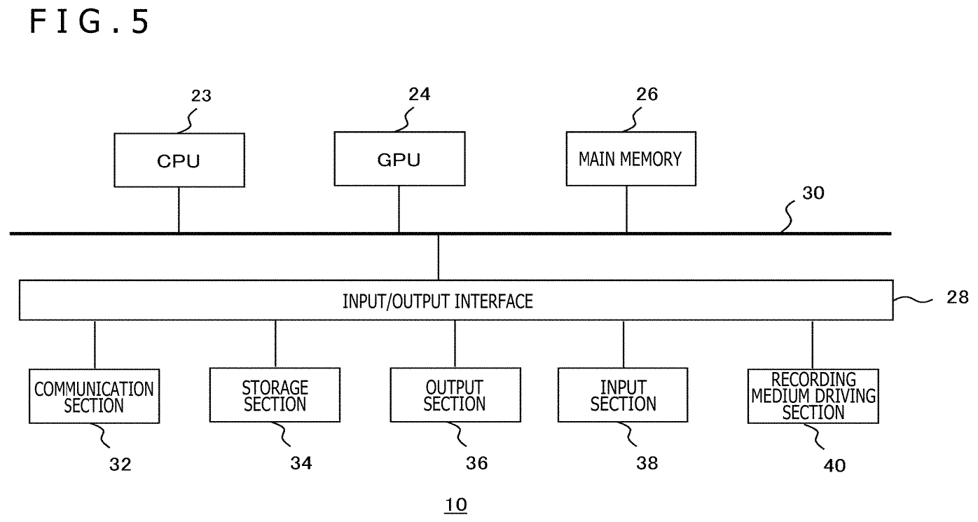

The display unit 11 displays display contents of the problem information input tool 14 as illustrated in FIG. 3 when a “+” mark located in an upper right field of the message board information 12a displayed on the display unit 11 in FIG. 2 is touched or clicked. That is, the display unit 11 displays display contents of the problem information input tool 14 in a “problem found” status. Specifically, the display unit 11 displays display contents that allow the presenter to input the problem information 14a. The problem information 14a includes a problem, a presenter of the problem, priority, a category, a problem type tag, a seven-waste tag, an improvement method tag, a site, a due date, and the like. The priority is selected from among a normal condition, a high-priority condition, and an urgent condition.

For example, the category is divided into workability, safety, and quality. For example, the problem type tag is divided into difficulty in the operation, the work-hour required for the operation, a set-up time, and an unnecessary walking distance. The seven-waste tag is divided into waste in excessive production, waste in tasks on hand, waste in transportation, waste in processing, waste in stocks, waste in motion, and waste in production of defective products. For example, the improvement method tag is divided into visualization, off-line set-up, and facilitation of the operation. For example, the site refers to a process in which the problem occurs.

The presenter inputs the problem information 14a by using the problem information input tool 14, and then touches an “update” button on the display unit 11. Then, the problem information 14a input by the presenter is stored in the problem information storage unit 15.

In FIG. 3, text information of the problem, an image file of the problem, a priority “normal”, categories “safety” and “quality”, a problem type tag “difficulty”, a seven-waste tag “waste in motion”, a site “process A”, and a due date “Mar. 31, 2019” are input as the problem information 14a.

The member designation tool 16 is used for designating members of the problem solution team for the problem information 14a. For example, the member designation tool 16 is installed in the mobile terminal or the stationary terminal, and is executable in the mobile terminal or the stationary terminal.

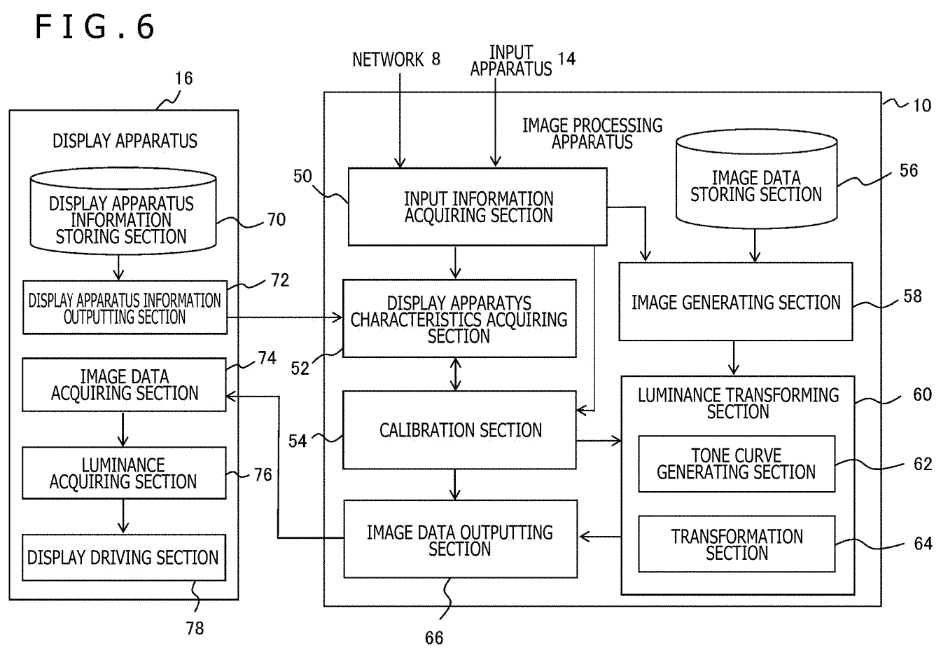

As described above, when the problem information 14a is input as illustrated in FIG. 3, the “problem found” sheet related to the input problem information 14a is added to the message board information 12a of FIG. 2. Then, a manager of the department or division where the problem information 14a is presented views the problem information 14a, and determines whether to take any measures. When the manager determines that any measures need to be taken, the manager touches an “addressing” status. Then, the display unit 11 displays display contents 16a in the “addressing” status as illustrated in FIG. 4. When the “addressing” status is touched, the sheet related to the problem information 14a moves to an “addressing” field in the message board information 12a of FIG. 2.

In the display contents 16a in the “addressing” status, the problem information 14a is displayed in an upper field, and items related to designation of the members of the problem solution team are displayed in a lower field. The members of the problem solution team include one leader and one or a plurality of assistants. Persons other than the presenter are normally designated as the leader and the assistant.

It is preferable that the problem be solved in cooperation, and therefore the problem solution team is constituted by the plurality of members. In particular, the system actively utilizes such a scheme that the members of the problem solution team (leader and assistant) are exclusively persons other than the presenter. That is, it is recommended that the presenter differ from the leader and the assistant.

If there is any special reason as in a case where the presenter needs to be included as a member of the problem solution team for some reason or a case where the presenter strongly desires to take measures, settings may be made to include the presenter as a member of the problem solution team. In this case, the members of the problem solution team are the presenter and a person other than the presenter. In this case, the presenter may be a leader or assistant. That is, the members of the problem solution team are (a) a leader who is the presenter and an assistant other than the presenter, (b) a leader other than the presenter and an assistant who is the presenter, or (c) a leader other than the presenter, an assistant who is the presenter, and an assistant other than the presenter.

The following two methods may be adopted to designate the leader of the problem solution team. In the first method, the leader is determined by the manager of the department or division where the problem information 14a is presented. In the second method, candidates for the leader are recruited in relation to the problem information 14a, and then one leader is determined among the candidates. When a plurality of candidates are present, the leader may be determined by the manager of the department or division where the problem information 14a is presented, or may be determined by voting or the like.

When the leader is designated, the leader is stored in the member storage unit 18 in association with the problem information 14a. For example, the manager determines an operator A as the leader. In this case, the manager inputs the operator A in a “leader” field of the display contents 16a illustrated in FIG. 4. When the manager touches the “update” button on the display unit 11 after inputting the leader by using the member designation tool 16, the operator A is designated as the leader. Then, the member storage unit 18 stores the operator A as the leader of the problem solution team for the problem information 14a. For example, when the operator A is designated as the leader, it is appropriate that the member designation tool 16 automatically and electronically notifies the operator A that the operator A is designated as the leader.

After the leader A is designated, assistants are designated as the members of the problem solution team by using the member designation tool 16. The assistants are designated by the leader A. As the assistants, there are a person belonging to the department or division where the problem information 14a is presented (assistant of a target section) and a person of a department or division other than the department or division where the problem information 14a is presented (assistant of another section).

The assistant of the target section and the assistant of another section are designated as follows. The leader A designates the assistant of the target section and the assistant of another section. At the time of designation, the leader A can refer to operator information stored in the operator information storage unit 17. The operator information storage unit 17 stores improvement abilities of target operators, or operation load conditions of the operators.

When designating the assistants, the leader A may choose the assistants by himself/herself. The leader A may recruit candidates for the assistants in relation to the problem information 14a, and then determine the assistants among the candidates. The assistants may be determined among the candidates by the leader A or by voting or the like.

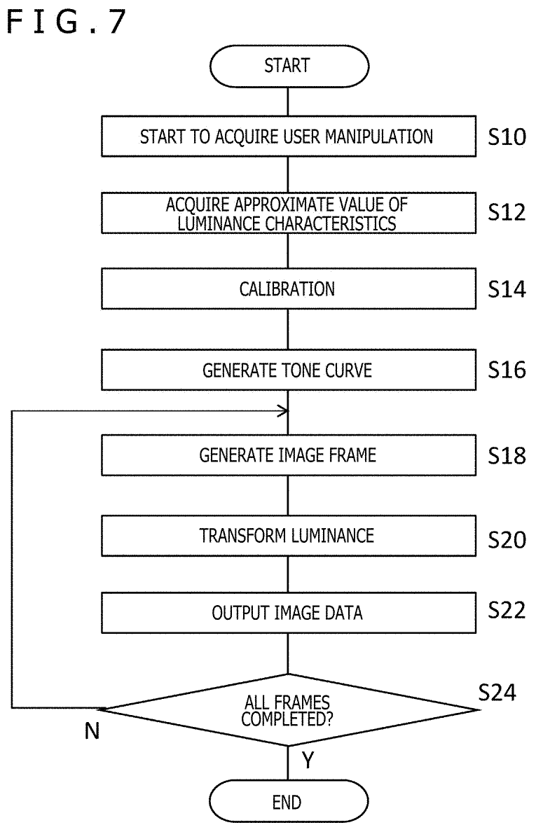

FIG. 5 illustrates display contents 16b on the display unit 11 in a state in which the leader A designates candidates for the assistant of the target section and the assistant of another section. As illustrated in FIG. 5, each assistant candidate is enclosed by a long dashed double-short dashed line. For example, operators B, C, F, and G are designated as assistant candidates of the target section, and operators D and H are designated as assistant candidates of another section.

As illustrated in FIG. 5, improvement abilities and current operation load conditions of the assistant candidates are represented by symbols, numerical values, or the like. In FIG. 5, the improvement abilities and the current operation load conditions of the assistant candidates are displayed on the display unit 11 based on information automatically acquired from the operator information storage unit 17 by the member designation tool 16. That is, the member designation tool 16 causes the display unit 11 to display the assistant candidates and information related to the assistant candidates based on the information stored in the operator information storage unit 17.

The leader A designates one or a plurality of assistants from the assistant candidates displayed on the display unit 11 by using the member designation tool 16. Specifically, the assistants are designated when the leader A touches the “update” button on the display unit 11 after designating the assistants by using the member designation tool 16. The member designation tool 16 encloses the designated assistants by continuous lines on the display unit 11, and deletes the undesignated assistant candidates from the display unit 11. After the designation, the improvement abilities and the operation load conditions are no longer displayed.

When the assistants are designated, the designated operators are stored in the member storage unit 18 as the assistants of the problem solution team. If the operators B, C, and D are designated as the assistants, it is appropriate that the member designation tool 16 automatically and electronically notify the operators B, C, and D that the operators B, C, and D are designated as the assistants.

The assistant of the target section and the assistant of another section are designated as the assistants, but the present invention is not limited to this case. For example, only the assistant of the target section may be designated as the assistant, or only the assistant of another section may be designated as the assistant. The leader A may determine who is designated as the assistant.

As described above, the leader and one or a plurality of assistants are designated as the members of the problem solution team for the problem information 14a by using the member designation tool 16. Thus, the leader and the assistants are easily and efficiently designated as the members of the problem solution team. When the assistants are designated, for example, the improvement abilities and the current operation load conditions are displayed as the information related to the assistant candidates. Therefore, the leader can easily determine which operator should be designated as the assistant from the assistant candidates. The members of the problem solution team are persons different from the presenter of the problem information 14a. Thus, it is possible to effectively utilize an ability of the person having the ability to find the problem and an ability of the person having the improvement ability. The member storage unit 18 stores the leader and the assistants designated as the members of the problem solution team in association with the problem information 14a.

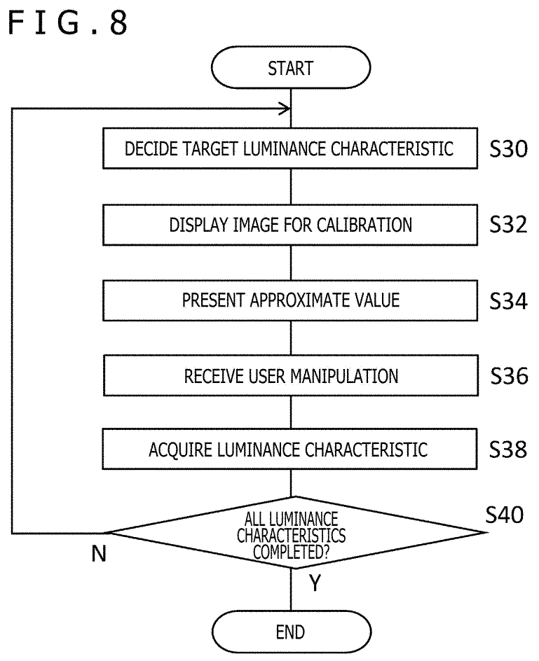

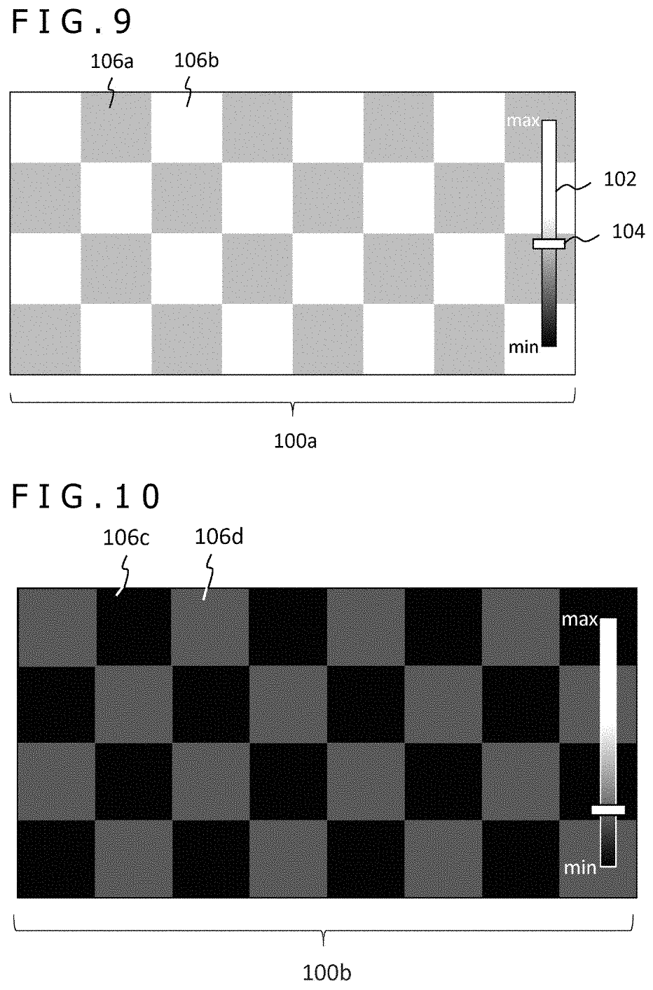

After the members of the problem solution team are designated, the members of the problem solution team can exchange opinions about a solution to the problem information 14a by using the opinion exchange tool 19. FIG. 6A and FIG. 6B illustrate display contents 19a on the display unit 11 when the opinion exchange tool 19 exerts its function.

The problem information 14a, the leader, and the assistants are displayed in an upper field of the display contents 19a. An opinion input field for text information of an opinion, an image file related to the opinion, and the like is provided in a field below an “assistant” field. The opinion can be input exclusively by the members of the problem solution team, that is, the leader and the assistants.

The leader or the assistant can input an opinion about the solution to the problem information 14a by using the opinion exchange tool 19. The types of the opinion include a comment and a proposal. An opinion inputting person inputs an opinion, determines whether the opinion is a comment or a proposal, and touches a “comment” button or a “proposal” button that applies. When the opinion inputting person touches the “update” button on the display unit 11, the input of the opinion is confirmed. When the input of the opinion is confirmed, the input opinion, the opinion inputting person, and a time when the opinion is input are stored in the opinion information storage unit 20 by the opinion exchange tool 19.

In a field below the opinion input field of the display contents 19a on the display unit 11, logs indicating details of previous opinion exchange are displayed in chronological order. In this embodiment, a new opinion is displayed at the top, and the oldest opinion is displayed at the bottom. That is, the opinion exchange tool 19 causes the display unit 11 to display, as the logs, information related to the opinions stored in the opinion information storage unit 20. Thus, the plurality of members of the problem solution team can view the logs of the exchanged opinions. That is, the plurality of members of the problem solution team can view their opinions and opinions of other persons in chronological order. Thus, the members of the problem solution team can easily grasp the opinion exchange.

In the display contents 19a, “edit” and “delete” buttons for a temporarily input opinion are displayed in the opinion log field. When the “edit” or “delete” button is touched by using the opinion exchange tool 19, the opinion can be edited or deleted.

In the opinion log field of the display contents 19a, evaluation of whether each opinion is good or bad (limited to a favorable evaluation in this embodiment) can be input by using the opinion exchange tool 19. The evaluation of whether the opinion is good or bad can be input by the members of the problem solution team. Depending on the settings, the evaluation may be input by a person other than the members of the problem solution team.

In FIG. 2, the disclosure range can be set in the message board information 12a. By setting the disclosure range, a person other than the members of the problem solution team can be permitted or forbidden to view the logs of the opinions by using the opinion exchange tool 19. When the person is permitted to view the logs, the permitted external viewer can input evaluation of whether the opinions are good or bad. In this embodiment, the number of favorable evaluations is displayed.

With the opinion exchange tool 19, the leader can input a conclusion of the solution, that is, a result of improvement based on the opinions of the members of the problem solution team. An input field for the conclusion of the solution is provided next to the “problem” field of the display contents 19a. Only the leader can input the conclusion of the solution, and the assistant cannot input the conclusion. When the conclusion of the solution is determined, the leader can clearly indicate which opinion is adopted at the time of inputting the conclusion of the solution so that the members of the problem solution team grasp that the opinion of a member is adopted. In this case, an “adopted” indication is added to the location of a corresponding opinion in the opinion logs. When the conclusion of the solution is input, the conclusion of the solution is stored in the opinion information storage unit 20.

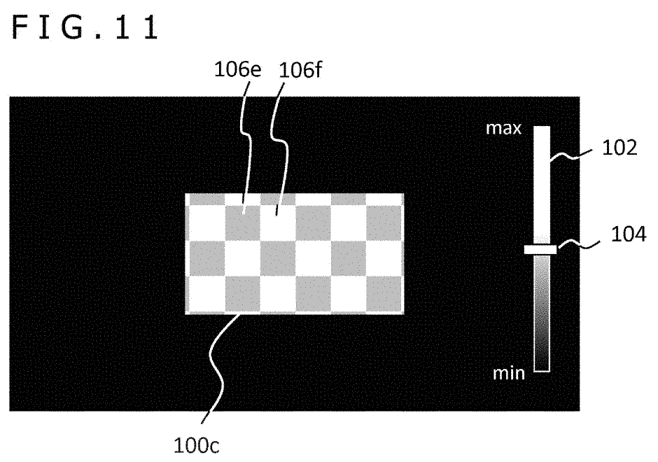

After the leader inputs the conclusion of the solution, the leader touches an “addressed” status by using the opinion exchange tool 19, thereby confirming that the solution has been implemented. FIG. 7 illustrates display contents 19b on the display unit 11 in this case. When the “addressed” status is touched, the sheet related to the problem information 14a moves to an “addressed” field in the message board information 12a of FIG. 2. Thus, the presenter can grasp, in the message board information 12a, that the solution to the problem information 14a presented by the presenter has been implemented.

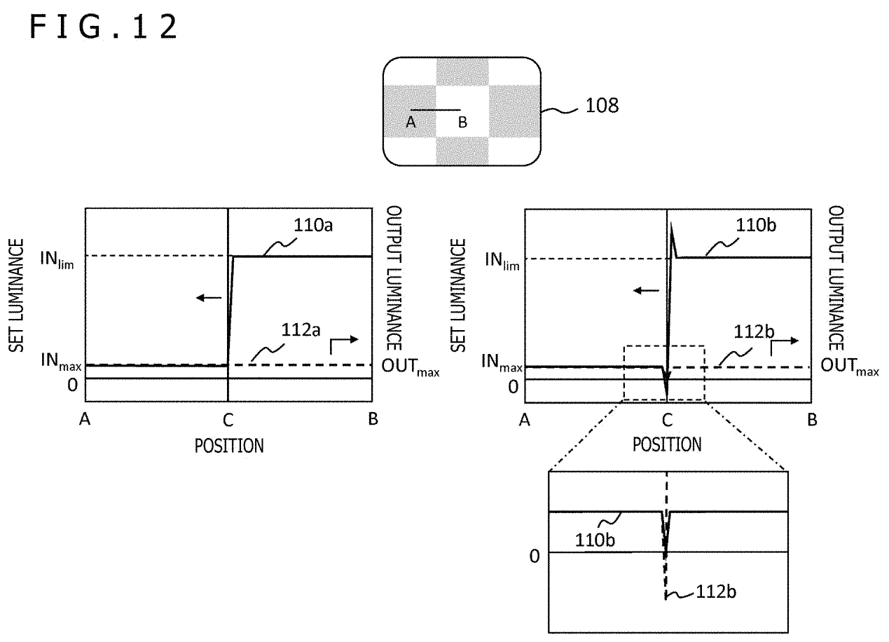

When the presenter selects the “addressed” sheet in the message board information 12a, the display unit 11 displays details 14b of the solution to the problem as illustrated in FIG. 8. When the solution has been implemented, the presenter can input a confirmation that the problem has been solved by using the problem information input tool 14. That is, when the presenter touches a “problem solved” status, the problem has been solved completely. When the “problem solved” status is touched, the sheet related to the problem information 14a moves to a “problem solved” field in the message board information 12a of FIG. 2. Thus, the presenter, the members of the problem solution team, and all the other persons who can view the message board can grasp that the problem information 14a has been solved.

Based on the activities to present the problem information 14a and to plan and implement the solution, the improvement ability evaluation unit 21 evaluates the improvement abilities of the operators involved in the activities. The operators may be the presenter, the leader, and the assistants. Description is given below of a case of evaluating an improvement ability of a first operator.

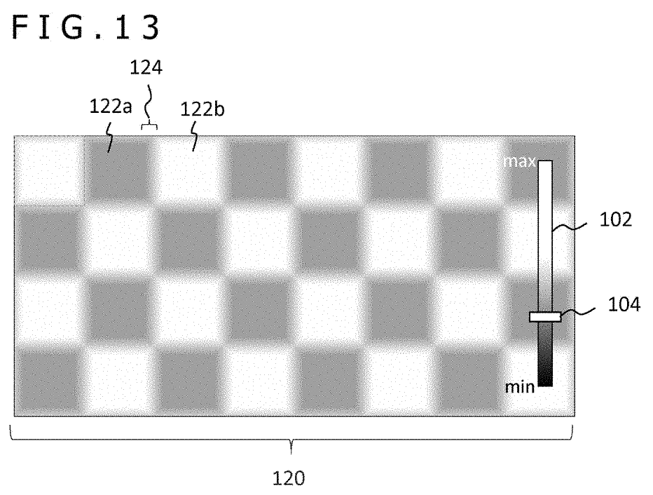

As illustrated in FIG. 9, elements 21a of the improvement ability are roughly divided into an “ability to find a problem”, an “ability to plan improvement”, and an “ability to achieve improvement”. The “ability to find a problem” is mainly an ability to be evaluated when the first operator is the presenter. The “ability to plan improvement” and the “ability to achieve improvement” are mainly abilities to be evaluated when the first operator is the leader or assistant. The major elements of the improvement ability may be other elements. The number of major elements of the improvement ability may be determined arbitrarily.

Each major element of the improvement ability is represented by an evaluation point at a plurality of grades (for example, five grades). The evaluation point of each major element of the improvement ability is calculated based on evaluation points related to a plurality of minor elements. Similarly to the major element, each minor element of the improvement ability is represented by an evaluation point at a plurality of grades (for example, five grades). For example, the evaluation point of the major element of the improvement ability is an average of evaluation points related to a plurality of corresponding minor elements. The evaluation point of the major element of the improvement ability may be a value obtained by assigning weights to a plurality of corresponding minor elements and performing calculation based on evaluation points of the minor elements and the weights assigned to the minor elements. Other calculation methods may be applied as well.

For example, each major element of the improvement ability is represented by a plurality of minor elements as follows. The major element “ability to find a problem” is divided into a “frequency of small insights”, a “breadth of small insights”, and a “depth of small insights” as the minor elements of the improvement ability. The major element “ability to plan improvement” is divided into a “breadth of ideas”, the “degree of added value”, and “ingenuity” as the minor elements of the improvement ability. The major element “ability to achieve improvement” is divided into the “degree of accomplishment of a method for implementing a solution” and the “degree of involvement of other persons” as the minor elements of the improvement ability. The minor elements of the improvement ability may be other elements. The number of minor elements of the improvement ability may be determined arbitrarily.

The evaluation point of each minor element of the improvement ability is calculated based on evaluation points related to a plurality of viewpoints. Similarly to the major element and the minor element, each viewpoint is represented by an evaluation point at a plurality of grades (for example, five grades). For example, the evaluation point of the minor element of the improvement ability is an average of evaluation points related to a plurality of corresponding viewpoints. The evaluation point of the minor element of the improvement ability may be a value obtained by assigning weights to a plurality of corresponding viewpoints and performing calculation based on evaluation points of the viewpoints and the weights assigned to the viewpoints. Other calculation methods may be applied as well.

The evaluation point related to the “frequency of small insights” that is one of the minor elements of the improvement ability corresponding to the major element “ability to find a problem” is calculated based on evaluation points of viewpoints related to the “number of pointed-out problems” and a “willingness to find a problem”. For example, the evaluation point related to the “number of pointed-out problems” is calculated based on the number of adopted presentations of problem information 14a input by the first operator as the presenter. The evaluation point related to the “willingness to find a problem” is calculated based on the number of presentations of problem information 14a input by the first operator as the presenter.

The evaluation point related to the “breadth of small insights” that is one of the minor elements of the improvement ability is calculated based on evaluation points of viewpoints related to the “number of options for problem finding” and the “breadth of vision to find a problem”. For example, the evaluation points related to the “number of options for problem finding” and the “breadth of vision to find a problem” are calculated based on the number of items in the tags. The “tags” may include all of the problem type tag, the seven-waste tag, and the improvement method tag, or may be limited to some of the tags. As the number of items in the tags increases, a problem is found in relation to more viewpoints. The evaluation point related to the “breadth of vision to find a problem” may be calculated based not only on the number of items in the tags but also on, for example, the opinion information from other persons about the problem information input by the first operator as the presenter.

The evaluation point related to the “depth of small insights” that is one of the minor elements of the improvement ability is calculated based on an evaluation point of a viewpoint related to a “multifaceted analysis”. The evaluation point related to the “multifaceted analysis” is calculated based on the number of items in the category. The evaluation point related to the “multifaceted analysis” may be calculated based not only on the number of items in the category but also on, for example, the opinion information from other persons about the problem information input by the first operator as the presenter.

The evaluation point related to the “breadth of ideas” that is one of the minor elements of the improvement ability corresponding to the major element “ability to plan improvement” is calculated based on an evaluation point of a viewpoint related to the “number of options for improvement proposal”. The evaluation point related to the “number of options for improvement proposal” is calculated based on the number of proposals for a solution offered by the first operator as the leader or assistant about the problem information input by another operator as the presenter. The evaluation point related to the “degree of added value” that is one of the minor elements of the improvement ability is calculated based on an evaluation point of a viewpoint related to the “degree of return on investment (ROI)”. The evaluation point related to the “degree of ROI” is calculated based on the number of adopted solutions proposed by the first operator as the leader or assistant. The evaluation point related to the “ingenuity” that is one of the minor elements of the improvement ability is calculated based on an evaluation point of a viewpoint related to the “degree of novelty or advancement”. The evaluation point related to the “degree of novelty or advancement” is calculated based on the number of favorable evaluations from other persons for the opinion about the solution.

The evaluation point related to the “degree of accomplishment” that is one of the minor elements of the improvement ability corresponding to the major element “ability to achieve improvement” is calculated based on evaluation points of viewpoints related to an “impact of improvement” and a “speed of improvement”. The evaluation point related to the “impact of improvement” is calculated based on the number of times the first operator belongs to the problem solution team. The evaluation point related to the “impact of improvement” is also calculated based on the opinion information provided by the first operator as the leader or assistant. The evaluation point related to the “speed of improvement” is calculated based on the ratio of completion to the number of cases where the first operator is involved in the implementation of the solution (completion ratio).

The evaluation point related to the “degree of involvement” that is one of the minor elements of the improvement ability is calculated based on evaluation points of viewpoints related to the “degree of involvement within a leader's section (first involvement degree)” and the “degree of involvement of another section (second involvement degree)”. The evaluation point related to the “degree of involvement within a leader's section” is calculated based on the degree of involvement of assistants within a section to which the first operator designated as the leader belongs. The evaluation point related to the “degree of involvement of another section” is calculated based on the degree of involvement of assistants of another section when the first operator is designated as the leader.

The evaluation points of the minor elements described above are calculated by using algorithms set in advance. The evaluation points of the major elements are also calculated by using algorithms set in advance. At this time, the weights assigned to the viewpoints and the minor elements are set to any appropriate values. For example, different weights are assigned to the evaluation point of the viewpoint related to the “degree of involvement within a leader's section” and the evaluation point of the viewpoint related to the “degree of involvement of another section” for evaluation of the minor element “degree of involvement”. Thus, it is possible to obtain evaluation points appropriate to the improvement ability desired by an evaluator.

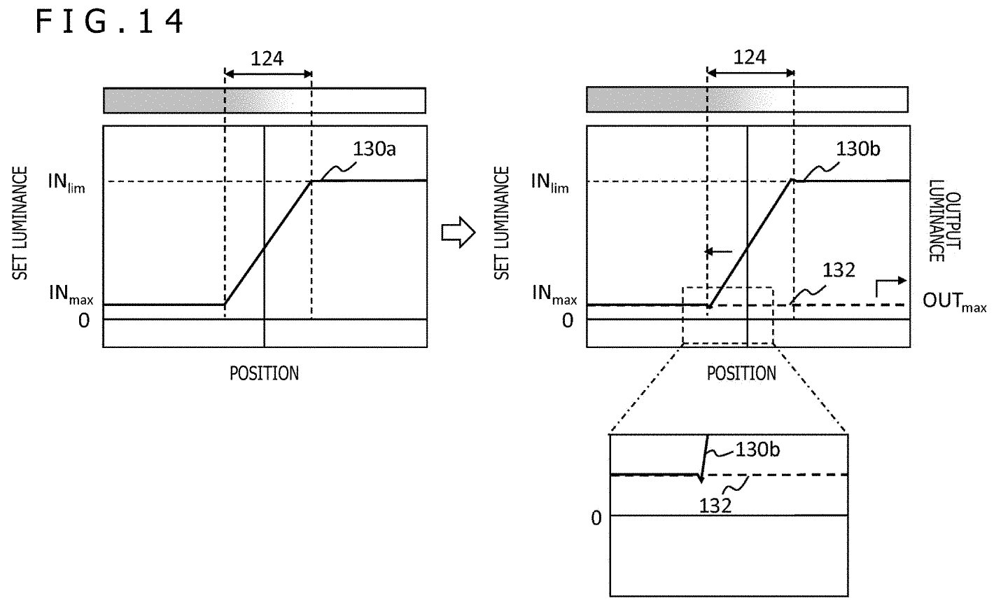

As illustrated in FIG. 10, the improvement ability evaluation unit 21 causes the display unit 11 to display the improvement ability calculated by the improvement ability evaluation unit 21. The improvement ability evaluation unit 21 may cause the display unit 11 to display the improvement ability as illustrated in FIG. 10, or may transmit data on the contents illustrated in FIG. 10 to the first operator, a supervisor, or the like.

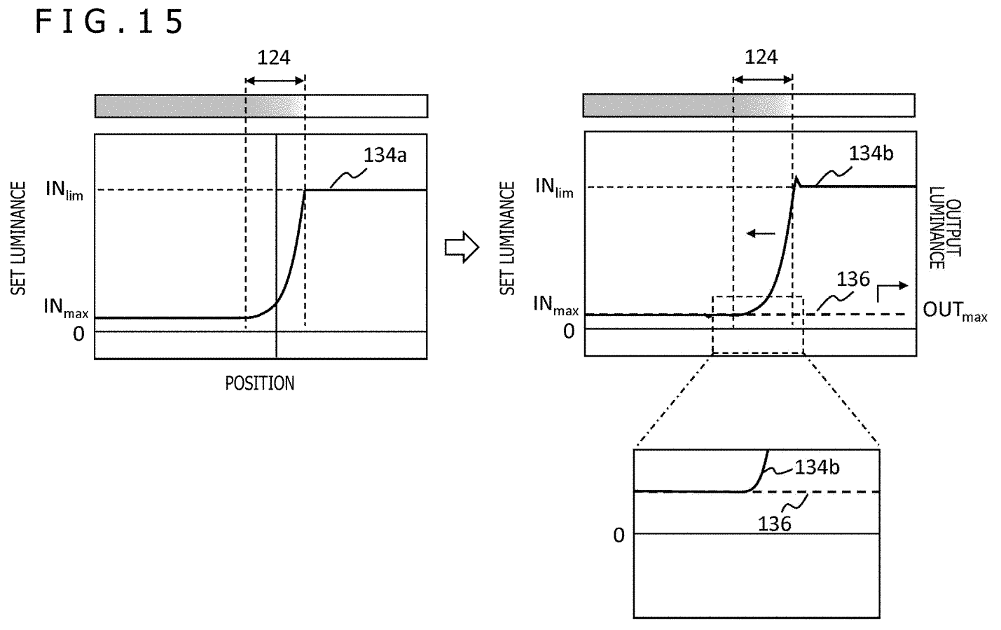

For example, the display unit 11 may display the improvement ability by a method using a radar chart. FIG. 10 illustrates a radar chart regarding the minor elements of the improvement ability. Alternatively, a radar chart regarding the major elements of the improvement ability may be displayed as illustrated in FIG. 11. The radar chart illustrated in FIG. 10 and the radar chart illustrated in FIG. 11 may be displayed while switching the two radar charts. The improvement ability may be displayed in a format other than the radar chart, such as a table showing the evaluation points as numerals, or a bar graph.

By displaying the improvement ability of each operator on the display unit 11, the operator can appropriately grasp his/her improvement ability. Thus, the operator can grasp how the improvement activity should be carried out in the future.

What is claimed is:

1. A problem solution system, comprising:
a problem information storage unit configured to store problem information input by a presenter;
a member storage unit configured to store a plurality of persons including at least persons other than the presenter and designated as members of a problem solution team for the problem information; and
an opinion exchange tool configured such that each of the plurality of designated members is allowed to input an opinion about planning or implementation of a solution to the problem information and the plurality of members are allowed to view the opinion.

2. The problem solution system according to claim 1, wherein the opinion exchange tool is configured such that the plurality of members are allowed to view a log of the opinion.

3. The problem solution system according to claim 1, wherein the opinion exchange tool is configured such that the members are allowed to input evaluation of whether the opinion is good or bad.

4. The problem solution system according to claim 3, wherein the opinion exchange tool is configured such that a person other than the members is permitted or forbidden for viewing and, when the person is permitted for the viewing, the person is allowed to input the evaluation of whether the opinion is good or bad.

5. The problem solution system according to claim 1, wherein the member storage unit is configured to store a leader of the problem solution team who is designated as one of the members, and one or a plurality of assistants of the problem solution team who are designated as one or a plurality of the members by the leader.

6. The problem solution system according to claim 5, further comprising a member designation tool configured such that the leader is allowed to designate the assistant from assistant candidates.

7. The problem solution system according to claim 6, further comprising an operator information storage unit configured to store improvement abilities of operators or operation load conditions of the operators, wherein
the member designation tool is configured to display the assistant candidates and information related to the assistant candidates based on information stored in the operator information storage unit.

8. The problem solution system according to claim 5, wherein the opinion exchange tool is configured such that the leader is allowed to input a conclusion of the planning of the solution or the implementation of the solution based on the opinion of each of the plurality of members.

9. The problem solution system according to claim 1, further comprising an improvement ability evaluation unit configured to evaluate an improvement ability of a first operator by using an algorithm set in advance based on at least one of:
(a) the number of presentations of the problem information input by the first operator as the presenter;
(b) opinion information from another person about the problem information input by the first operator as the presenter; and
(c) opinion information provided by the first operator about the problem information input by another operator as the presenter.

10. The problem solution system according to claim 5, further comprising an improvement ability evaluation unit configured to evaluate an improvement ability of a first operator by using an algorithm set in advance based on (d) a first involvement degree to which, when the first operator is designated as the leader, a person of a section to which the leader belongs is designated as the assistant, or a second involvement degree to which a person of a section other than the section to which the leader belongs is designated as the assistant.

11. The problem solution system according to claim 10, wherein the improvement ability evaluation unit is configured to evaluate the first involvement degree and the second involvement degree by assigning different weights.
